(19) United States
(12) Patent Application Publication
(10) Pub. No.: US 2015/0149176 A1
(43) Pub. Date: May 28, 2015

(54) SYSTEM AND METHOD FOR TRAINING A CLASSIFIER FOR NATURAL LANGUAGE UNDERSTANDING

(71) Applicant: AT&T Intellectual Property I, L.P., Atlanta, GA (US)

(72) Inventors: Danilo GIULIANELLI, Whippany, NJ (US); Patrick Guy HAFFNER, Atlantic Highlands, NJ (US)

(73) Assignee: AT&T Intellectual Property I, L.P., Atlanta, GA (US)

(21) Appl. No.: 14/092,258

(22) Filed: Nov. 27, 2013

(51) Int. Cl. G10L 15/18

(52) U.S. Cl. CPC G10L 15/18
USPC 704/257

(57) ABSTRACT

Disclosed herein are systems, methods, and computer-readable storage devices for building classifiers in a semi-supervised or unsupervised way. An example system implementing the method can receive a human-generated map which identifies categories of transcriptions. Then the system can receive a set of machine transcriptions. The system can process each machine transcription in the set of machine transcriptions via a set of natural language understanding classifiers, to yield a machine map, the machine map including a set of classifications and a classification score for each machine transcription in the set of machine transcriptions. Then the system can generate silver annotated data by combining the human-generated map and the machine map. The algorithm can include different branches for when the machine transcription is available, when partial results are available, when no results are found for the machine transcription, and so forth.

### BACKGROUND

1. Technical Field

The present disclosure relates to speech processing and more specifically to training classifiers for use in natural language understanding.

2. Introduction

Speech recognition and processing is an increasingly important part of many consumer and business applications. Classifiers are often used in speech processing applications. For example, a natural language understanding (NLU) classifier can assist in classifying user utterances properly after they are processed by an automatic speech recognition (ASR) engine. However, human labeling of transcribed utterances into a fixed set of categories is usually needed to generate, build, or train an NLU classifier used to retrieve the semantic meaning from the output of an ASR engine. In the human labeling approach, a human user or expert listens to or reads each utterance in order to determine its semantic category. The human user or expert enters those semantic categories into a machine. The semantic categories are then used to train an NLU classifier. This procedure of human labeling is very labor intensive and costly. Any measures that reduce human involvement in this process or increase the efficiency of human involvement can bring great cost savings in building NLU classifiers.

### BRIEF DESCRIPTION OF THE DRAWINGS

FIG. 1 illustrates a high-level view of an algorithm for building a natural language understanding classifier;

FIG. 2 illustrates an example flow diagram for mapping categories to utterances;

FIG. 3 illustrates an example flow diagram for training models for use with a classifier;

FIG. 4 illustrates an example method embodiment; and

FIG. 5 an example system embodiment.

### DETAILED DESCRIPTION

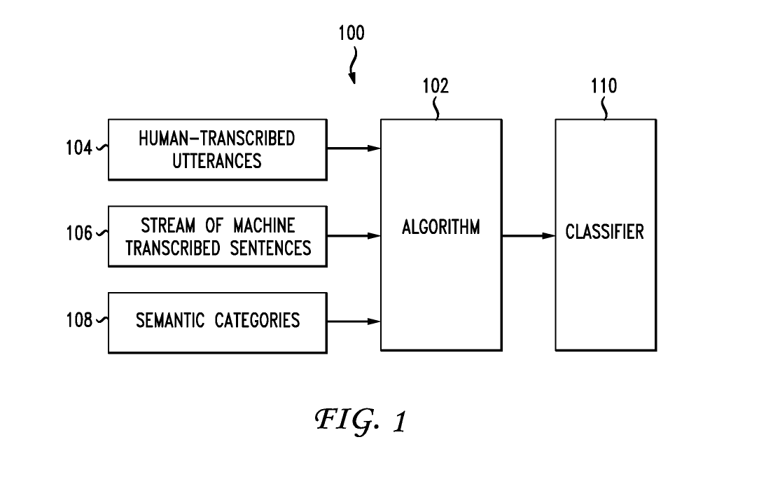

Disclosed herein are systems, methods, and computer-readable storage devices implementing an algorithm for performing semi-supervised or unsupervised machine learning and domain adaptation to build a classifier that extracts a semantic category from a short sentence, for instance the recognition output of an automatic speech recognition (ASR) engine. FIG. 1 illustrates a high-level view 100 of an algorithm 102 for building a natural language understanding (NLU) classifier 110. The algorithm 102 takes as input a set of human transcribed utterances 104 with the corresponding categories used as a base reference. The set of human transcribed utterances can be relatively small. The algorithm 102 takes as input a stream of machine transcribed sentences 106. The stream of machine transcribed sentences 106 can be continuous, can be in real-time, or can be a recorded stream of previously generated machine transcribed sentences. In one embodiment, the stream of machine transcribed sentences 106 is the output from one or multiple ASR engines. The algorithm 102 also takes as input semantic categories 108 attached to the transcribed sentences by one or several existing NLU classifiers. An example system implementing this algorithm 102 can combine these three inputs 104, 106, 108 data to produce a new NLU classifier 110 that improves on existing NLU classifiers (not shown), in particular if the new speech domain is slightly different from the domains for which the existing classifiers were trained.

An illustrative scenario is provided that illustrates these principles with some specific examples and details, with the understanding that these specific examples and details are not limiting. This example begins by recording a small amount of utterances, such as 1,000 utterances, from people calling a customer service 1-800 number. One or more human transcribers listen to and transcribe the utterances. Based on a given set of rules, the human transcribers can also map the transcriptions to pre-defined categories. Because of the assumed trust in the ability of the human transcribers, the transcriptions and classifications into categories are a ‘gold’ set of transcription and semantic category data. The system can use this ‘gold’ set of transcriptions and semantic category data to generate ‘silver’ transcriptions and semantic category data which is automatically generated and has a confidence score above a certain threshold. Thus, the ‘gold’ annotated data is expensive and human labor intensive to produce, but presumed to be accurate, while ‘silver’ annotated data is substantially less expensive to produce via automated processes, and has a sufficient confidence in its accuracy. The table below illustrates several example transcriptions and corresponding semantic categories.

| Transcription | Semantic Category |
|---|---|
| A bad phone connection | Fix-Basic |
| About my phone bill | Vague-BillingGroup |
| A representative please | Request-Agent |
| I'd like to pay my bill | Pay-Bill |
| Internet problems | Fix-Internet |
| I want new phone service | Acquire-Service |

The system can save the transcriptions and mappings to specific semantic categories in a file. With the above input, special tools can generate a ‘gold’ NLU classifier model. The system can later use the ‘gold NLU classifier model to automatically classify an input utterance and return an n-best list of corresponding categories. An IVR automated system can then take the best category from the classifier and, for example, route the call to an appropriate customer service agent. However, tens of thousands of transcribed and classified utterances, which are expensive in terms of time and money if done by humans, are typically necessary in order to build a good classifier model. This system provides a shortcut or a way to reduce the amount of human involvement to build a good classifier model.

The system can use a transcription for each input utterance, and the mapped semantic category used to route a call. If the system continues to record more customer service calls, the system continues to generate or use transcriptions and map transcriptions to semantic categories in order to retrain and improve the classifier.

One way to get transcriptions from recorded calls is via human transcribers. Alternatively, the system can process the utterances via one or multiple ASRs. ASRs use statistical models to produce a transcription and as a result ASRs also output a confidence score indicating whether the transcription is reliable. Normalized ASR scores are usually a number between 1 and 100, where the higher the number the higher the confidence the transcription is correct. In contrast, human transcriptions are presumed to always be correct, and are considered ‘gold,’ i.e. the system can assign human transcriptions a confidence score of 100.

For example, suppose the system receives 1,000 new utterances, and sends 500 utterances for human transcription and sends the other 500 to one or multiple ASRs. For simplicity, this example assumes a single ASR engine. Of the 500 utterances transcribed by the ASR, 300 have a confidence score greater than 70 and the remaining 200 have a confidence score below 70. 70 is provided here as an example threshold, but the actual threshold value can vary and may be a different value. At the end of this process, the system has available 500 human transcribed utterances, and 300 machine transcribed utterances exceeding the threshold confidence score for a total of 800 usable transcriptions.

The system proceeds to map each of these 800 usable transcriptions into a semantic category. While the system could send all of these transcriptions to humans, that approach would be expensive. So the system can reduce the amount of human categorization. The system can send all 800 transcriptions through one or multiple NLU classifiers, but this example assumes, for simplicity, a single NLU classifier. The system can gather the output category plus confidence score for each of the 800 transcriptions. These classifiers can use the initial ‘gold’ NLU model built from the ‘gold’ 1000 transcription/category pairs or use a different model from a closely related domain. An example output mapping table is provided below.

| Transcription | Semantic Category | Confidence Score |
|---|---|---|
| Noise on my phone line | Fix-Basic | 88 |
| Why is my bill so high | Vague-BillingGroup | 81 |
| Disconnect the phone | Cancel-Service | 75 |
| . . . 800 total transcriptions | | |

Then the system processes all 800 transcriptions and attempts first to find an exact match with the gold set of annotated data. If the system finds a match, the system can reuse the same semantic category. Next, if no exact match is found, the system searches for a partial match, such as with a lattice-based approach. For example, the system can use ASR lattices (or any other data generated and recorded by the ASR process) to compare and search for matches between the transcriptions and ‘gold’ annotated data. If a partial match is found, the system can reuse the corresponding semantic category. For example, suppose one of the new transcription is “about pay uh my phone bill”. The system can partially match that transcription to one of the transcriptions in the ‘gold’ set (“about my phone bill”), and map the transcription to the Vague-BillingGroup semantic category. If instead the unique transcription has no human category associated with it, and the partial match fails, the system can search for the transcription in all the maps for each available NLU classifier.

Also in this case the system can try both the exact match or partial transcription match, and if two or more classifiers concur by mapping the same output category then the system can trust and use the classification. If instead only one NLU classifier is matching or partially matching, then the system can take the output from the classifier with the highest confidence score. In the example mentioned above, if the input transcription is “about pay uh my phone bill”, the system can map the transcription to the Vague-BillingGroup category from the ‘gold’ set and start building an output map. If the next transcription is for example “I want to disconnect the phone”, the system will map that transcription to Cancel-Service by selecting the category from the map that was built from the set of 800 new transcriptions, since there neither a full nor partial match in the ‘gold’ set exists, and the system has a partial match in the set of 800 new transcriptions with a confidence score (75) above the threshold.

At the end of this process, which started with 800 new transcriptions, the system ends up with a new map with 800 transcriptions mapped to their semantic categories, and can save this new map into a new file.

Finally the system can build a new model based on contents of the file containing the 1000 golden transcriptions+categories and the latter file with the new 800 transcriptions+categories. The system can then test the new model. If the new model yields better performance, the system can substitute the initial model built with only 1000 lines. Then the system can iterate again with additional new utterances.

Various embodiments and details of the disclosure are described in detail below. While specific implementations are described, it should be understood that this is done for illustration purposes only. Other components and configurations may be used without parting from the spirit and scope of the disclosure.

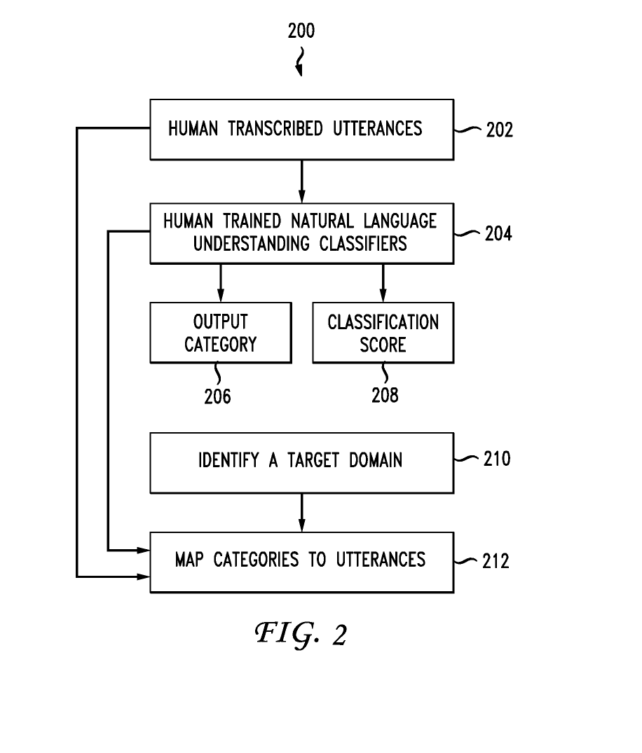

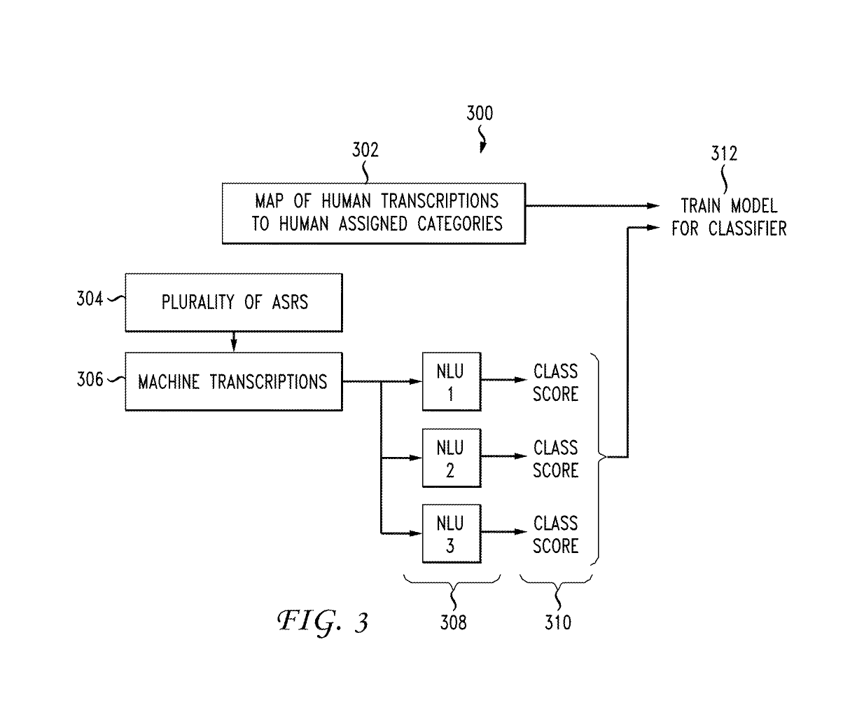

In the approach set forth herein, an example system can use a set of human transcribed utterances and the corresponding human mapped semantic categories for the human transcribed utterances to build an initial version of a classifier model. These human transcribed utterances and human mapped semantic categories are ‘gold’ data that is considered trusted because the data is human generated and assumed to be correct. Then the system can collect the transcriptions generated by one or multiple ASRs from a set of new utterances that are not part of the gold data set. Some of these transcriptions may fully or partially match utterances in the gold data set, but this is not known in advance. The system can then collect the output category and the corresponding classification score, and apply an unsupervised algorithm to automatically derive the corresponding category needed for building the classifier, thus enriching a reference database of human annotated utterances. If a human category is not found, the machine-generated category can be accepted based on concurrent matching of at least two of the NLU classifiers and/or based on the classification scores being greater than predefined thresholds. Parts of this approach are outlined below in terms of six steps and various inputs at some of the steps. These steps and inputs are illustrated by FIGS. 2 and 3, and are illustrative. Other steps may be introduced or equivalent steps substituted for the ones described below. Further, the order of the steps is illustrative and may change in some situations.

The system can perform semi-supervised or unsupervised learning according to the following steps. For a target domain, the system can load the reference database of human transcribed utterances 202 and human selected semantic categories for those utterances 202. This information is considered ‘gold’ annotated data, because the data is human-generated and assumed to be reliable. The system loads this gold annotated data, i.e. utterances 202 and the semantic categories, as human trained classifiers 204 which generate output categories 206 and classification scores 208 for the utterances 202. Then, for an identified target domain 210, the system can use the classifiers 204 to map additional transcriptions to semantic categories.

The steps outlined below then use the ‘gold’ annotated data, that is created via human input, to process additional inputs to generate ‘silver’ annotated data that a machine determines has a sufficiently high confidence score when matched to the ‘gold’ annotated data. The ‘silver’ annotated data can then be used to train a classifier, train a language model, build a regression model for confidence scoring, build an acoustic model, etc. First, the system can gather transcriptions into single list, even if they come from slightly different domains. FIG. 3 shows an example flow diagram 300 for training models for use with a classifier. The input for this step is a map of machine transcriptions 306 generated by a group of ASR engines 304. Second, for every available NLU classifier 308 (which can be trained for other, slightly different domains), the system can train a model for a classifier 312 by building a separate map between the transcription from the single list of machine transcriptions and the corresponding category. The system can optionally incorporate the associated NLU classification scores 310 for the transcriptions. If the transcription comes directly from an ASR engine rather than a precompiled list, the system can add an available ASR confidence score to the map. Besides the transcription and the confidence score, the system can also consider word lattices to find a match for an utterance and an existing semantic category in the ‘gold’ annotated data. The input for this step is a map for each existing NLU classifier that associates machine transcriptions with machine assigned categories. In some embodiments, the system can merge the second step and the third step, as each transcription is produced by an ASR engine which immediately calls a NLU classifier. In this case, the system can build a single machine transcription list after calling all ASR/NLU pipeline engines and all available audio utterances.

Third, for each unique transcription in the list of machine transcriptions, the system can search the reference database of human transcriptions which were input to the first step. If the system finds an identical transcription, the system can retrieve the corresponding category from the reference database map, and output the transcription plus category pair as is, or without modification.

Fourth, if the unique transcription (B) has no human category associated with it, the system can attempt to make or find a partial match. The system can use ASR lattices (or any other data generated and recorded by the ASR process) to compare and search for matches between the transcriptions and ‘gold’ annotated data. For example, the system can assign a greater weight to words in the transcriptions that are part of a vocabulary for a target category, and assign smaller weight to less important words such as conjunctions or predicates. The system can also apply partial match techniques that are based on edit distance between sentences, or lexical or morphological distances between words. If a partial match is successful, the system can retrieve the corresponding semantic category from the ‘gold’ annotated data and the corresponding map between human transcriptions and human assigned semantic categories.

Fifth, if the unique transcription has no human category associated with it, and the partial match fails, the system can search for the transcription from available ASR outputs and retrieve the corresponding semantic category. If the system locates more than one transcription, then the system can retrieve multiple corresponding categories. If at least 2 categories match, the system can output the matching transcription plus categories.

Sixth, if the unique transcription has no human category associated with, the partial match fails, and none of the categories match for any 2 of the matching NLU classifier outputs, then the system can select the category from the engine for which both the corresponding ASR engine confidence (if available) and NLU classifier scores are above predefined thresholds. To be consistent between different classifiers, the system can optionally normalize these scores. For example, the system can sort and scale the raw scores so that the normalized score occupies a position in a list of raw scores ranging from 0 to 100.

This system can reduce the cost of manually labeling the data, while simultaneously improving accuracy, and reducing the necessary time to adapt to a new domain. Adapting to new domains can enhance speech understanding applications and expand availability to new markets.

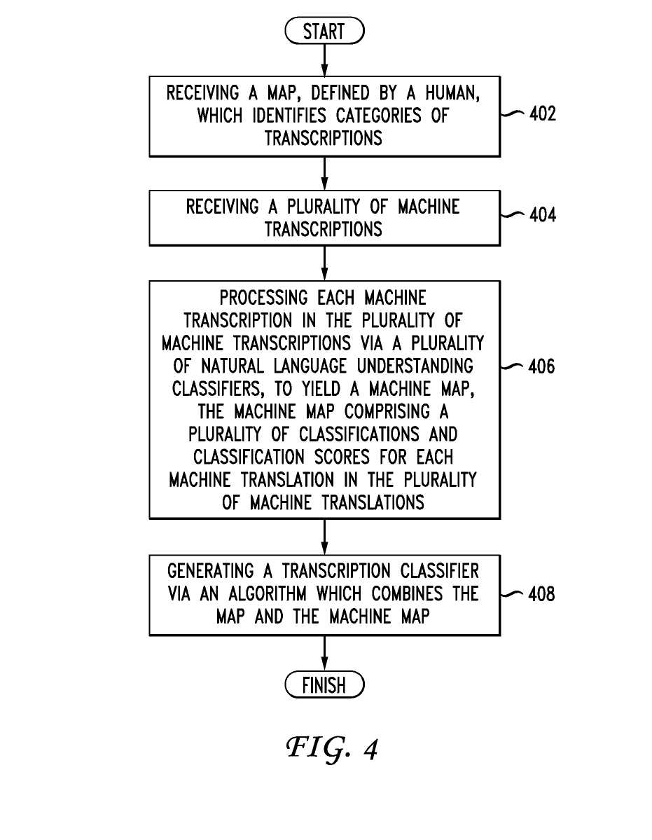

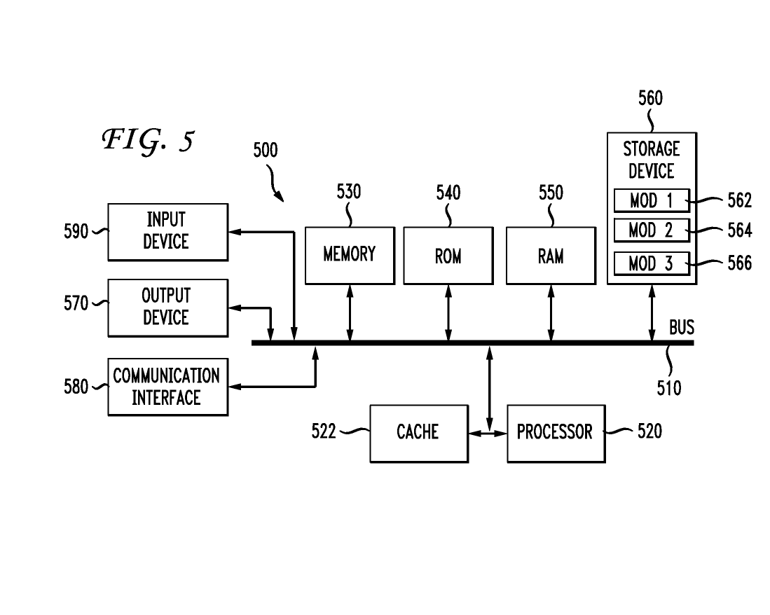

The disclosure now turns to the exemplary method embodiment shown in FIG. 4. For the sake of clarity, the method is described in terms of an exemplary system 500 as shown in FIG. 5 configured to practice the method. The steps outlined herein are exemplary and can be implemented in any combination thereof, including combinations that exclude, add, or modify certain steps. FIG. 4 illustrates an example method embodiment for generating a classifier. A system implementing operations as outlined in the example method can receive a map, optionally defined by a human, which identifies categories of transcriptions (402). The map can, for example, be completely or partially human defined. The system can receive a set of machine transcriptions (404). The system can also receive additional human transcribed utterances. The system can receive the set of machine transcriptions as a single list, as a group of lists, individually, or a combination thereof.

The system can process each machine transcription in the set of machine transcriptions via a set of natural language understanding classifiers, to yield a machine map, the machine map made up of a set of classifications and at least one classification score for each machine transcription in the set of machine transcriptions (406). More than one classification score can be used. The set of machine transcriptions can be generated by multiple distinct automatic speech recognizers. In one embodiment, each of the set of natural language understanding classifiers is tuned for a different language domain, vocabulary, and/or task. In this case, the system can weight the machine map based on a distance of a respective corresponding language domain to a target language domain for the classifier to be generated. For example, the machine map can assign a greater weight for domains that are closer to the desired or target language domain. The map can also associate human-generated transcriptions with human-assigned categories.

The system can generate silver annotated datavia an algorithm which combines the human-generated map and the machine map. The algorithm can include multiple different branches for handling various conditions. For example, when the system finds a machine transcription in the map, the system can add the machine transcription and an associated category to the silver annotated data. When the system cannot find a machine transcription in the map, the system can perform a partial match of weighted words in the machine transcription to words in the map, and upon finding a match above a threshold similarity, the system can add the match and an associated category to the silver annotated data. When the partial match yields no results for the machine transcription, the system can search the natural language classifiers for the machine transcription and, upon finding matching machine transcriptions and corresponding category in multiple natural language classifiers, the system can add the matching machine transcriptions and corresponding category to the silver annotated data. Further, when none of the previous conditions are met and yield no results for the machine transcription, the system can select a category corresponding to a natural language classifier from the set of natural language classifiers that has a highest confidence score associated with a classification, and the system can add the machine transcription and the category to the silver annotated data.

With reference to FIG. 5, an exemplary system and/or computing device 500 includes a processing unit (CPU or processor) 520 and a system bus 510 that couples various system components including the system memory 530 such as read only memory (ROM) 540 and random access memory (RAM) 550 to the processor 520. The system 500 can include a cache 522 of high speed memory connected directly with, in close proximity to, or integrated as part of the processor 520. The system 500 copies data from the memory 530 and/or the storage device 560 to the cache 522 for quick access by the processor 520. In this way, the cache provides a performance boost that avoids processor 520 delays while waiting for data. These and other modules can control or be configured to control the processor 520 to perform various operations or actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the processor. The processor 520 may be a self-contained computing system, containing multiple cores or processors, a bus, memory controller, cache, etc. A multi-core processor may be symmetric or asymmetric. The processor 120 can include multiple processors, such as a system having multiple, physically separate processors in different sockets, or a system having multiple processor cores on a single physical chip. Similarly, the processor 120 can include multiple distributed processors located in multiple separate computing devices, but working together such as via a communications network. Multiple processors or processor cores can share resources such as memory 130 or the cache 122, or can operate using independent resources. The processor 120 can include one or more of a state machine, an application specific integrated circuit (ASIC), or a programmable gate array (PGA) including a field PGA.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 560 can include software modules 562, 564, 566 for controlling the processor 520. The system 500 can include other hardware or software modules. The storage device 560 is connected to the system bus 510 by a drive interface. The drives and the associated computer-readable storage devices provide nonvolatile storage of computer-readable instructions, data structures, program modules and other data for the computing device 500. In one aspect, a hardware module that performs a particular function includes the software component stored in a tangible computer-readable storage device in connection with the necessary hardware components, such as the processor 520, bus 510, display 570, and so forth, to carry out a particular function. In another aspect, the system can use a processor and computer-readable storage device to store instructions which, when executed by the processor, cause the processor to perform operations, a method, or other specific actions. The basic components and appropriate variations can be modified depending on the type of device, such as whether the device 500 is a small, handheld computing device, a desktop computer, or a computer server. When the processor 120 executes instructions to perform “operations”, the processor 120 can perform the operations directly and/or facilitate, direct, or cooperate with another device or component to perform the operations.

Although the exemplary embodiment(s) described herein employs the hard disk 560, other types of computer-readable storage devices which can store data that are accessible by a computer, such as magnetic cassettes, flash memory cards, digital versatile disks (DVDs), cartridges, random access memories (RAMs) 550, read only memory (ROM) 540, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 520. The functions these blocks represent may be provided through the use of either shared or dedicated hardware, including, but not limited to, hardware capable of executing software and hardware, such as a processor 520, that is purpose-built to operate as an equivalent to software executing on a general purpose processor. For example the functions of one or more processors presented in FIG. 5 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 540 for storing software performing the operations described below, and random access memory (RAM) 550 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5 can practice all or part of the recited methods, can be a part of the recited systems, and/or can operate according to instructions in the recited tangible computer-readable storage media. Such logical operations can be implemented as modules configured to control the processor 520 to perform particular functions according to the programming of the module. For example, FIG. 5 illustrates three modules Mod1 562, Mod2 564 and Mod3 566 which are modules configured to control the processor 520. These modules may be stored on the storage device 560 and loaded into RAM 550 or memory 530 at runtime or may be stored in other computer-readable memory locations.

One or more parts of the example computing device 500, up to and including the entire computing device 500, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 520 can include all types of processors disclosed herein, including a virtual processor. However, when referring to a virtual processor, the processor 520 includes the software components associated with executing the virtual processor in a virtualization layer and underlying hardware necessary to execute the virtualization layer. The system 500 can include a physical or virtual processor 520 that receive instructions stored in a computer-readable storage device, which cause the processor 520 to perform certain operations. When referring to a virtual processor 520, the system also includes the underlying physical hardware executing the virtual processor 520.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code means in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

We claim:

1. A method comprising:
receiving a map which identifies categories of human transcribed utterances;
receiving a plurality of machine generated transcriptions;
processing each machine transcription in the plurality of machine transcriptions via a plurality of natural language understanding classifiers, to yield a machine map, the machine map comprising a plurality of classifications and a classification score for each machine transcription in the plurality of machine transcriptions; and
generating, via a processor, silver annotated data by combining the map and the machine map.

2. The method of claim 1, wherein the plurality of machine transcriptions is generated using a plurality of distinct automatic speech recognizers.

3. The method of claim 2, wherein the combining comprises:
(1) when a machine transcription is found in the map, adding the machine transcription and an associated category to the silver annotated data;
(2) when the machine transcription is not found in the map, performing a partial match of weighted words in the machine transcription to words in the map, and upon finding a match above a threshold similarity, adding the match and an associated category to the silver annotated data;
(3) when the partial match yields no results for the machine transcription, search each of the plurality of natural language classifiers for the machine transcription and, upon finding matching machine transcriptions and corresponding category in multiple natural language classifiers, adding the matching machine transcription and corresponding category to the silver annotated data; and
(4) when steps (1)-(3) yield no results for the machine transcription, selecting a category corresponding to a natural language classifier in the plurality of natural language classifiers having a highest confidence score associated with a classification, and adding the machine transcription and the category to the silver annotated data.

4. The method of claim 1, wherein each of the plurality of natural language understanding classifiers is tuned for a different language domain.

5. The method of claim 4, further comprising:
weighting the machine map based on a distance of a respective language domain to a target language domain.

6. The method of claim 1, wherein the map associates human-generated transcriptions with human-assigned categories.

7. The method of claim 1, wherein the plurality of machine transcriptions is received as a single list.

8. A system comprising:
a processor; and
a computer-readable storage medium storing instructions which, when executed by the processor, cause the processor to perform operations comprising:
receiving a map which identifies categories of transcriptions;
receiving a plurality of machine transcriptions;
processing each machine transcription in the plurality of machine transcriptions via a plurality of natural language understanding classifiers, to yield a machine map, the machine map comprising a plurality of classifications and a classification score for each machine transcription in the plurality of machine transcriptions; and
generating silver annotated data by combining the map and the machine map.

9. The system of claim 8, wherein the plurality of machine transcriptions is generated using a plurality of distinct automatic speech recognizers.

10. The system of claim 9, wherein the combining comprises:
(1) when a machine transcription is found in the map, adding the machine transcription and an associated category to the silver annotated data;
(2) when the machine transcription is not found in the map, performing a partial match of weighted words in the machine transcription to words in the map, and upon finding a match above a threshold similarity, adding the match and an associated category to the silver annotated data;
(3) when the partial match yields no results for the machine transcription, search each of the plurality of natural language classifiers for the machine transcription and, upon finding matching machine transcriptions and corresponding category in at least two of the natural language classifiers, adding the matching machine transcription and corresponding category to the silver annotated data; and
(4) when steps (1)-(3) yield no results for the machine transcription, selecting a category corresponding to a natural language classifier in the plurality of natural language classifiers having a highest confidence score associated with a classification, and adding the machine transcription and the category to the silver annotated data.

11. The system of claim 8, wherein each of the plurality of natural language understanding classifiers is tuned for a different language domain.

12. The system of claim 11, the computer-readable storage device further storing instructions which result in the method further comprising:
weighting the machine map based on a distance of a respective language domain to a target language domain.

13. The system of claim 8, wherein the map associates human-generated transcriptions with human-assigned categories.

14. The system of claim 8, wherein the plurality of machine transcriptions is received as a single list.

15. A computer-readable storage device storing instructions which, when executed by a computing device, cause the computing device to perform operations comprising:
receiving a map which identifies categories of transcriptions;
receiving a plurality of machine transcriptions;
processing each machine transcription in the plurality of machine transcriptions via a plurality of natural language understanding classifiers, to yield a machine map, the machine map comprising a plurality of classifications and a classification score for each machine transcription in the plurality of machine transcriptions; and
generating silver annotated data by combining the human generated map and the machine map.

16. The computer-readable storage device of claim 15, wherein the plurality of machine transcriptions are generated using a plurality of distinct automatic speech recognizers.

17. The computer-readable storage device of claim 16, wherein the combining comprises:
(1) when a machine transcription is found in the map, adding the machine transcription and an associated category to the silver annotated data;
(2) when the machine transcription is not found in the map, performing a partial match of weighted words in the machine transcription to words in the map, and upon finding a match above a threshold similarity, adding the match and an associated category to the silver annotated data;
(3) when the partial match yields no results for the machine transcription, search each of the plurality of natural language classifiers for the machine transcription and, upon finding matching machine transcriptions and corresponding category in multiple natural language classifiers, adding the matching machine transcription and corresponding category to the silver annotated data; and
(4) when steps (1)-(3) yield no results for the machine transcription, selecting a category corresponding to a natural language classifier in the plurality of natural language classifiers having a highest confidence score associated with a classification, and adding the machine transcription and the category to the silver annotated data.

18. The computer-readable storage device of claim 15, wherein each of the plurality of natural language understanding classifiers is tuned for a different language domain.

19. The computer-readable storage device of claim 18, further comprising:
weighting the machine map based on a distance of a respective language domain to a target language domain.

20. The computer-readable storage device of claim 15, wherein the map associates human-generated transcriptions with human-assigned categories.
